(19) United States
(12) Patent Application Publication
(10) Pub. No.: US 2015/0260241 A1
(43) Pub. Date: Sep. 17, 2015

(54) Hand-Operated Tool Device With A Brake Mechanism For Braking A Machining Tool

(71) Applicant: HILTI AKTIENGESELLSCHAFT, Schaan (LI)

(72) Inventor: Adrian Steingruber, Schwabmuenchen (DE)

(73) Assignee: Hilti Aktiengesellschaft, Schaan (LI)

(21) Appl. No.: 14/433,324

(22) PCT Filed: Oct. 1, 2013
(86) PCT No.: PCT/EP2013/070420

§ 371 Date: Apr. 2, 2015

(30) Foreign Application Priority Data
Oct. 3, 2012 (DE) 102012218072.9

(51) Int. Cl. F16D 49/10; B27B 5/38; B27B 17/08; B24B 47/26

(52) U.S. Cl. CPC F16D 49/10; B24B 47/26; B27B 5/38; B27B 17/083

(57) ABSTRACT

A hand-operated tool device with a brake mechanism for braking a machining tool is disclosed. The tool device has a drive device, a band brake with a brake drum and a brake band that loops around the brake drum, and a control device with a brake switch for activating the band brake. A first end of the brake band is connected with the brake switch via a transmission device. A pivot-mounted brake lever is connected between the brake band and transmission device and the brake lever is pre-tensioned by a brake spring. A second end of the brake band is connected with a tension spring. The spring rigidity of the tension spring is greater than the spring rigidity of the brake spring.

This application claims the priority of International Application No. PCT/EP2013/070420, filed Oct. 1, 2013, and German Patent Document No. 10 2012 218 072.9, filed Oct. 3, 2012, the disclosures of which are expressly incorporated by reference herein.

### BACKGROUND AND SUMMARY OF THE INVENTION

The current invention refers to a hand-operated tool device with a brake mechanism for braking a machining tool.

Under the term “tool device” in the context of the current invention all tool devices are summarized that drive a machining tool around an axis of rotation during the processing of a work piece. Typical examples of such tool devices are a cutoff grinder, an angle grinder, a circular saw, a chain saw and a core drill. Tool devices that are at least partially operated by hand by the user during the processing of a work piece are labeled hand operated. In addition to tool devices that are operated directly by the operator over the work piece, tool devices that are installed on a guiding carriage are also counted among hand-operated tool devices. In the process the tool device is operated via a mechanical or electrical remote control mechanism and the guiding carriage is operated with the tool device by the operator by hand over the work piece.

Motor chain saws with a safety brake and an inertia brake are known from DE 36 39 650 A1. Both brakes activate a common mechanical band brake with a brake drum and a brake band that loops around the brake drum. The safety brake is a mandatory safety device for motor chain saws, which brings the saw chain to a standstill within 150 milliseconds in case of a kickback of the motor chain saw without intervention by the operator. Additionally, the safety brake can be manually activated by the operator via a hand protection guard. The hand protection guard is positioned between and upper hand grip and the saw chain and is activated by a swiveling movement in the direction of the saw chain. The front hand grip is positioned between the saw chain and a motor housing. In addition to the front hand grip the motor chain saws have a rear hand grip, which is positioned on the side of the front hand grip that is turned away from the saw chain. The overrun brake serves to reduce the stopping time of the saw chain by a few seconds. The overrun brake consists of a brake switch and a transmission device which is connected with the brake switch and the brake band of the band brake. The brake switch for the overrun break is integrated in the gas switch for activating a drive device for the saw chain or in the safety switch for releasing the gas switch, with the switches being positioned on the rear hand grip. The gas switch is positioned on the internal side and the safety switch is positioned on the external side of the rear hand grip. The brake band is firmly connected on a first end with a housing part of the motor chain saw and hooked into a second end on a pivot-mounted brake lever. The brake lever is pre-tensioned via a brake spring and connected with the transmission device.

In the band brake, the friction action between the crooked areas of the brake band and the brake drum causes a blocking of the brake band on the brake drum. When braking, a tractive force is exerted on the first end of the brake band via the transmission device and the brake lever. The tractive force on the brake band changes with the angle of contact of the brake band on the brake drum and increases in the direction of the second end of the brake band, which is attached on the housing part. Due to the increasing friction action, the tractive force on the second end of the brake band increases abruptly and there is a blocking of the brake drum. The brake band adheres to the brake drum and can no longer slide over the brake drum. A disadvantage is that the blocking of the brake drum results in a pitching movement of the tool device. The pitching movement is particularly problematic in hand-operated tool devices that have a machining tool with a high mass inertia, because the pitching movement increases with the mass inertia of the machining tool.

The task of the current invention consists in the development of a brake mechanism for braking a machining tool, in which the risk of pitching movements when braking the hand-operated tool device is reduced. Furthermore, a blocking of the brake band on the brake drum should be prevented or at least eliminated as quickly as possible.

According to the invention it is planned that a second end of the brake band is connected with a tension spring, with the tension spring being connected on an end turned away from the brake band with a housing part of the tool device. The tension spring between the brake band and the housing part prevents a blocking of the brake band on the brake drum and quickly eliminates a blocking of the brake band. A tractive force is exerted on the brake band via the brake switch and the transmission device. Due to the increasing friction action between the crooked areas of the brake band and the brake drum, the tractive force on the second end of the brake band increases and the dynamic friction of the brake band on the brake drum transitions into an adhesive force. Due to the increase of the tractive force on the brake band a point is reached at which the tractive force on the second end of the brake band exceeds the force of the tension spring and the tension spring is stretched. Due to the stretching of the tension spring, the tractive force on the second end of the brake band is reduced and the adhesive force of the brake band on the brake drum transitions into dynamic friction; the blocking of the brake drum is eliminated. As soon as the tractive force on the second end of the brake band falls below the force of the tension spring, the tension spring contracts and the brake band slides over the brake drum.

Preferably the maximum expansion of the tension spring is limited by a first stopper. By limiting the maximum expansion of the tension spring an overstretching of the tension spring is securely prevented, so that the tension spring exhibits no or only limited wear and can return to its home position.

Preferably the minimum expansion of the tension spring is limited by a second stopper. In the process the tension spring is also pre-tensioned in case of minimum expansion. By limiting the minimum expansion of the tension spring it is ensured that the tension spring returns to its home position.

Particularly preferably the brake band has a stop element, which can be moved between the first stopper and the second stopper. The stop element is positioned on the second end of the brake band, which is turned toward the tension spring. Due to the movability of the stop element between the stoppers, the deflection of the tension spring is limited. An overstretching of the tension spring is securely prevented so that the tension spring exhibits little or no wear and can return to its home position.

In a preferred embodiment a pivot-mounted brake lever is interposed between the first end of the brake band and the transmission device, with the brake lever being pre-tensioned via a brake spring. Via the brake spring a pre-tension is exerted on the brake lever, causing a permanent tractive force to be exerted on the brake band. The reset force of the brake spring causes the brake lever to be turned back into its home position if no external force acts on it.

Particularly preferably the spring rigidity of the tension spring is significantly greater than the spring rigidity of the brake spring. The tension spring is designed to be significantly more rigid than the brake spring to make it so that the tension spring is only stretched when the brake band is blocked. As long as the brake band slides over the brake drum, the tension spring is positioned in its home position and does not influence the band brake. The spring rigidity of the tension spring is designed so that the tractive force on the second end of the brake band exceeds the spring rigidity of the tension spring when blocking the brake band and the spring rigidity of the tension spring exceeds all other forces occurring in normal brake operation.

Embodiment examples of the invention are described below with reference to the drawing. This drawing should not necessarily represent the embodiment examples to scale; instead the drawing, where appropriate for explanation, is executed in schematic and/or slightly distorted form. With regard to additions to models immediately recognizable from the drawing, reference is made to the relevant state of the art. In the process it must be kept in mind that various modifications and amendments can be performed with regard to the form and the detail of the embodiment without deviating from the general idea of the invention. The characteristics of the invention disclosed in the description, the drawing and the claims may be significant both individually in themselves and in any combination for the further development of the invention. Additionally, all combinations of at least two of the characteristics disclosed in the description, the drawing and/or the claims fall within the scope of the invention. The general idea of the invention is not restricted to the exact form of the detail of the preferred embodiment shown and described in the following or restricted to an object that would be limited compared to the object claimed in the claims. At the given measurement ranges, values lying within the stated limits should also be disclosed as limit values and be arbitrarily replaceable and claimable. For the sake of simplicity, in the following the same reference signs are used for identical or similar parts or parts with identical or similar function.

### BRIEF DESCRIPTION OF THE DRAWINGS

FIG. 1 illustrates a hand-operated tool device according to the invention designed as a cutoff grinder with a brake mechanism for braking a cutoff wheel and a control device for the cutoff grinder;

FIG. 2 shows the brake mechanism of the cutoff grinder of FIG. 1 consisting of a mechanical band brake with an anti-blocking mechanism; and

FIGS. 3A-C show the band brake with the anti-blocking mechanism of FIG. 2 with open band brake (FIG. 3A), during the brake application with blocked band brake (FIG. 3B) and during the brake application after the engagement of the anti-blocking mechanism (FIG. 3C).

### DETAILED DESCRIPTION OF THE DRAWINGS

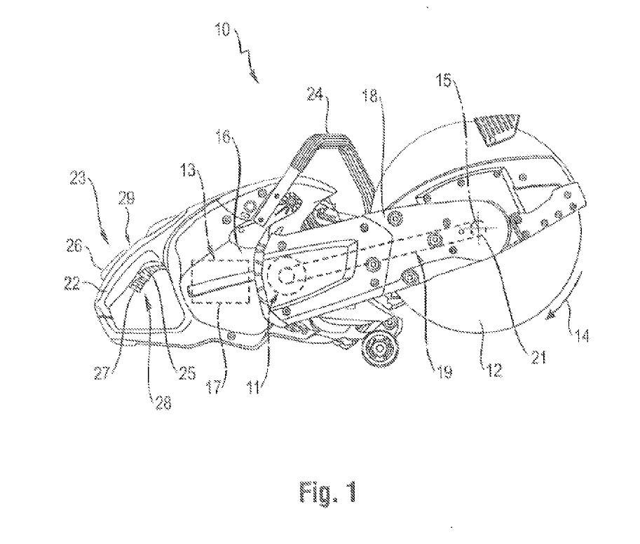

FIG. 1 shows a hand-operated tool device 10 according to the invention that is designed in the form of a cutoff grinder, with a brake mechanism 11 for braking a drive device in a three-dimensional representation.

The cutoff grinder 10 has a machining tool designed as a cutoff wheel 12, which is driven by a drive device 13 in a rotational direction 14 around an axis of rotation 15. Here all drive components for the cutoff wheel 12 are summarized under the term “drive device.” The drive device 13 of the cutoff grinder 10 shown in FIG. 1 comprises a drive motor 17 positioned in a motor housing 16, a belt drive 19 positioned in a supporting arm 18 and an output shaft 21, on which the cutoff wheel 12 is mounted. If necessary, additional transmission components can be connected between the drive motor 17 and the belt drive 19.

To operate the cutoff grinder 10, a first hand grip 22 is planned, which has a control device 23 and in the embodiment example shown in FIG. 1 is designed as a “rear handle.” A hand grip is referred to as a rear handle which is positioned on the side of the motor housing 16 turned away from the cutoff wheel 12. Alternatively, the first hand grip 22 can be designed as a “top handle,” which is positioned above the motor housing 16. To guide the cutoff grinder 10, in addition to the first hand grip 22 a second hand grip 24 is planned, which is positioned between the cutoff wheel 12 and the first hand grip 22. The second hand grip 24 is designed as a handle tube in the embodiment example shown in FIG. 1, or can alternatively be designed as one piece with the motor housing 16. Because the first hand grip 22, independently of a rear or top handle arrangement, is always located in the rear area of the tool device 10 and therefore behind the second hand grip 24, generally a rear hand grip 22 and a front hand grip 24 can be spoken of.

The control device 23 comprises a gas switch 25 to activate the drive device 13, a safety switch 26 for releasing the gas switch 25 and a brake switch 27 to activate the brake mechanism 11. The control device 23 is positioned in the rear hand grip 22 and is operated by the operator with one hand. The gas switch 25 and the brake switch 27 are positioned on the internal side 28 of the rear hand grip and are, for example, activated with the index finger (gas switch 25) and the middle finger (brake switch 27). The safety switch 26 is positioned on an external side 29 of the rear hand grip 22 and is activated, for example, with the palm of the hand or the internal side of the hand.

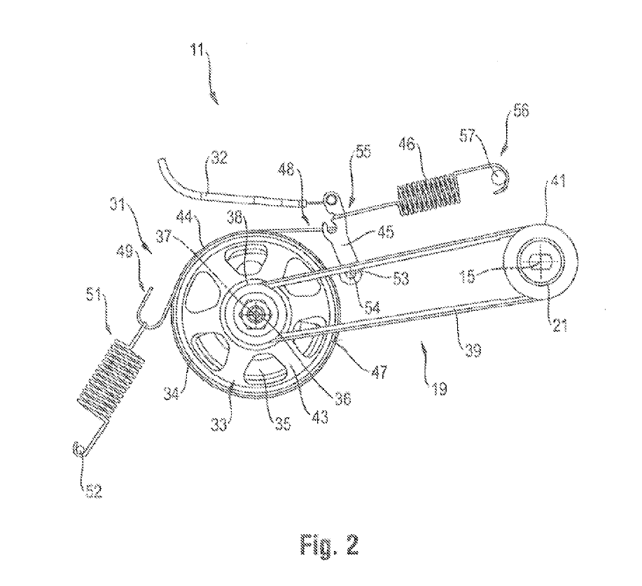

FIG. 2 shows the brake mechanism 11 of the cutoff grinder 10, which in addition to the brake switch 27 (shown in FIG. 1) consists of a mechanical band brake 31 and a transmission device 32. The transmission device 32 is designed in FIG. 2 as a Bowden cable and transmits a movement of the brake switch 27 to the band brake 31, which acts on a centrifugal clutch 33 of the drive device 13. Alternatively, the transmission device 32 can be designed as a cable pull, connecting rod or similar.

The centrifugal clutch 33 is positioned between the drive motor 17 and the belt drive 19 and ensures that the cutoff wheel 12 does not rotate at low speeds, such as when idling or when starting the cutoff grinder 10. The centrifugal clutch 33 has a bell housing 34, against which the centrifugal weights 35 are pressed outward due to the centrifugal force when in operation. The drive motor 17 drives a crankshaft 36 around an axis of rotation 37. The bell housing 34 is connected in a torque-proof way with a drive disk 38 that is pivot mounted on the crankshaft 36. The drive belt 39 is operated via the drive disk 38 and a drive disk 41 positioned on the output shaft 21. The drive disk 38, the drive belt 39 and the drive disk 41 make up the belt drive 19.

The band brake 31 comprises a brake housing, a brake drum 43, a brake band 44, a brake lever 45 and a brake spring 46. The bell housing 34 of the centrifugal clutch 33 simultaneously forms the brake drum 43 of the band brake 31. The brake band 44 loops around the brake drum 43 on its outer circumferential wall 47. The brake band 44 and the brake drum 43 form friction partners, which work together during braking and bring the bell housing 34 to a standstill. Via the brake spring 46 a pre-tension is exerted on the brake lever 45, causing a permanent tractive force to be exerted on the brake band 44. The reset force of the brake spring 46 causes the brake lever 45 to be turned back into its home position if no external force acts on it. The brake mechanism 11 is designed so that the band brake 31 is opened when the brake switch 27 is activated and is closed when the brake switch 27 is released.

The brake band 44 has a first end 48 and a second end 49. The first end 48 of the brake band 44 is hooked in on the brake lever 45. The second end 49 is connected with an anti-blocking mechanism 51, which is firmly attached on the other end with a housing part 52 of the cutoff grinder 10. The brake lever 45 is pivot mounted around a bolt 53, which is attached with the housing part 52 and fixes an axis of rotation 54. The brake spring 46 has a free end 55 and a fixed end 56, with the free end 55 being hooked in on the brake lever 45 and the fixed end 56 being attached via a bolt 57 on the housing part 52.

FIG. 2 shows an embodiment example in which the bell housing 34 of the centrifugal clutch 33 forms the brake drum 43 of the band brake 31. Alternatively, the brake drum can be designed as a separate component and for example be attached via an adapter plate on the housing part of the cutoff grinder 10. The integration of the brake drum 43 and the bell housing 34 allows for a compact construction while simultaneously saving weight for the tool device. The separate design has the advantage that the band brake can be reconditioned without great retrofitting costs on tool devices.

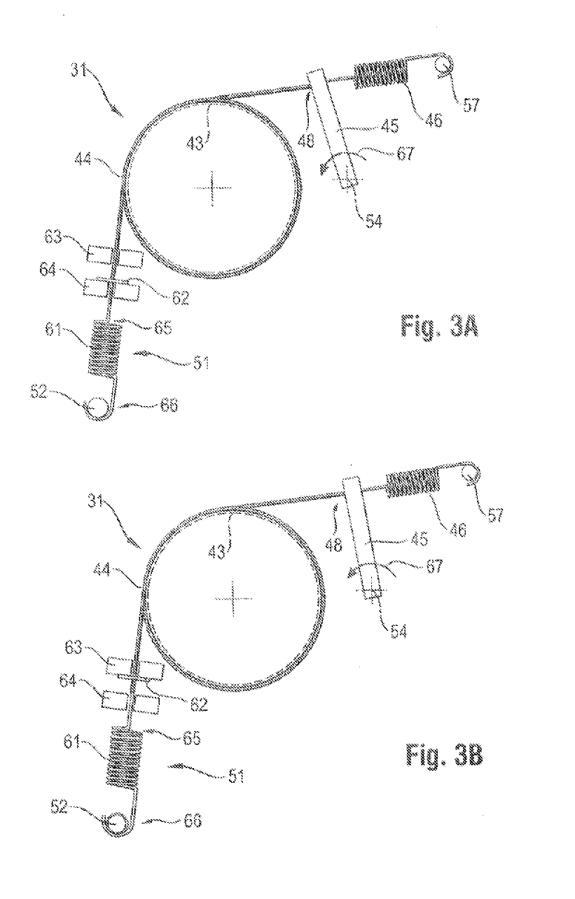

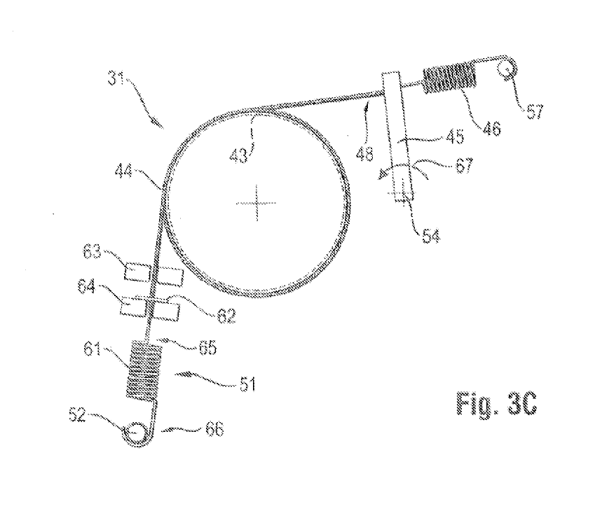

FIGS. 3A-C show the band brake 31 with the anti-blocking mechanism 51 in a first position with band brake 31 opened (FIG. 3A), in a second position during the brake application (FIG. 3B) and in a third position at the end of the brake application with the band brake 31 closed (FIG. 3C).

The anti-blocking mechanism 51 comprises a tension spring 61, a stop element 62, a first stopper 63 and a second stopper 64. The stop element 62 is connected with the second end 49 of the brake band 44 and can be moved between the first stopper 63 and the second stopper 64. The tension spring 61 has a free end 65 and a fixed end 66. The free end 65 is connected with the second end 49 of the brake band 44 and the fixed end 66 is attached to the housing part 52.

FIG. 3A shows the band brake 31 and the anti-blocker mechanism 51 in the first position with the band brake 31 opened. The band brake 31 is opened when the brake switch 27 is activated. When the brake switch 27 is activated, the Bowden cable 32 is tensioned and the brake lever 45 is rotated across from its home position in a rotational direction 67 on its axis of rotation 54. Because the first end 48 of the brake band 44 is hooked on the brake lever 45, the brake band 44 relaxes and a gap forms between the brake band 44 and the circumferential wall 47 of the brake drum 43. The brake drum 43, which simultaneously forms the bell housing 34 of the centrifugal clutch 33, is released. When the band brake 31 is opened, the tension spring 61 of the anti-blocking mechanism 51 is relaxed and the stop element 62 lies on the second stopper 64.

To slow down the cutoff wheel 12, the operator releases the brake switch 27. The release of the brake switch 27 causes the Bowden cable 32 to relax and the tractive force on the brake lever 45 and on the brake spring 46 suspended on brake lever 45 to decrease. The reset force of the brake spring 46 causes the brake lever 45 to be rotated counter to the rotational direction 67 around its axis of rotation 54. During the rotation the brake lever 45 exerts a tractive force on the brake band 44. The tractive force changes with the angle of contact of the brake band 44 on the brake drum 43 and increases in the direction of the second end 49 of the brake band 44. If the tractive force on the brake band 44 increases abruptly, particularly on the second end 49, due to the increasing friction action between the crooked areas of the brake band 44 and the brake drum 43, a blocking of the brake drum 43 occurs. The brake band 44 adheres to the brake drum 43 and can no longer slide over the brake drum 43.

Due to the increase of the tractive force on the brake band 44 a point is reached at which the tractive force on the second end 49 of the brake band 44 exceeds the force of the tension spring 61. As soon as the tractive force exceeds the force of the tension spring 61, the tension spring 61 is stretched until the tractive force on the second end 49 falls below the force of the tension spring 61 or the stop element 62 lies on the first stopper 63 (FIG. 3B). A further tensioning of the tension spring 61 is not possible because the maximum displacement is limited by the stop element 62 and the first stopper 63. Due to the stretching of the tension spring 61, the tractive force on the second end 49 of the brake band 44 is reduced and the adhesive force of the brake band 44 on the brake drum 43 transitions into dynamic friction. As soon as the tractive force that acts on the second end 49 of the brake band 44 has fallen below the force of the tension spring 61, tension spring 61 contracts. The stop element 62 connected with tension spring 61 moves until the stop element 62 lies against the second stopper 64 (FIG. 3C).

The spring rigidity of tension spring 61 is significantly greater than the spring rigidity of the brake spring 46. The more rigid design of tension spring 61 causes the tension spring 61 to only be stretched when the brake band 44 adheres on the brake drum 43. As long as the brake band 44 slides over the brake drum 43, the tension spring 61 is positioned in its home position shown in FIG. 3A and does not influence the band brake 31. The spring rigidity of the tension spring is designed so that the tractive force on the second end 49 of the brake band 44 exceeds the spring rigidity when blocking the brake band 44 and the spring rigidity of the tension spring 61 exceeds all other forces occurring in normal brake operation.

1.-6. (canceled)

7. A hand-operated tool device with a brake mechanism for braking a machining tool, comprising:
a drive device, wherein the machining tool is drivable by the drive device around an axis of rotation;
a band brake including a brake drum and a brake band that loops around the brake drum, wherein the brake band has a first end and a second end;
a control device with a brake switch, wherein the brake switch is connected via a transmission device to the first end of the brake band; and
a tension spring with a first end and a second end;
wherein the second end of the brake band is connected to the first end of the tension spring and wherein the second end of the tension spring is connected to a housing part of the hand-operated tool device.

8. The hand-operated tool device according to claim 7 further comprising a first stopper, wherein a maximum expansion of the tension spring is limited by the first stopper.

9. The hand-operated tool device according to claim 8 further comprising a second stopper, wherein a minimal expansion of the tension spring is limited by the second stopper.

10. The hand-operated tool device according to claim 9, wherein the brake band has a stop element and wherein the stop element is movable between the first stopper and the second stopper.

11. The hand-operated tool device according to claim 7 further comprising a pivot-mounted brake lever disposed between the first end of the brake band and the transmission device, wherein the pivot-mounted brake lever is pre-tensioned by a brake spring.

12. The hand-operated tool device according to claim 11, wherein a spring rigidity of the tension spring is greater than a spring rigidity of the brake spring.
